(19) United States
(12) Patent Application Publication
(10) Pub. No.: US 2024/0243992 A1
(43) Pub. Date: Jul. 18, 2024

(54) NETWORK AWARE LOAD BALANCING FOR ARTIFICIAL INTELLIGENCE NETWORK TRANSPORT

(71) Applicant: Meta Platforms, Inc., Menlo Park, CA (US)

(72) Inventors: Zeeshan Altaf Lokhandwala, Redwood City, CA (US); Arvind Srinivasan, San Jose, CA (US)

(73) Assignee: Meta Platforms, Inc., Menlo Park, CA (US)

(21) Appl. No.: 18/154,216

(22) Filed: Jan. 13, 2023

(51) Int. Cl. H04L 45/24; H04L 43/0829; H04L 45/00

(52) U.S. Cl. CPC H04L 45/24; H04L 43/0829; H04L 45/566

(57) ABSTRACT

Systems, apparatuses and methods provide technology that identifies a message that is to be transmitted across a network, divides the message into a plurality of portions that are arranged in a first order, and generates a plurality of packets based on the plurality of portions. The technology maps different network paths for the plurality of packets to be transmitted to a destination, sets headers of the plurality of packets to represent the first order and the different network paths, transmits the plurality of packets over the network in an out-of-order fashion to the destination based on the headers, and arranges the plurality of transmitted packets into the first order based on the headers of the plurality of packets.

### TECHNICAL FIELD

Examples of the disclosure generally relate to network aware load balancing of packets. That is, examples may distribute packets in an out-of-order fashion to reduce the occurrence of hot spots.

### BACKGROUND

Some applications may operate in a network environment and pass communications between different nodes. The messages may be various information related to the application, such as weights, biases, inputs, outputs, etc. The amount of data that is passed between different nodes may be particularly large for machine learning and artificial intelligence. The latency of such applications may be heavily influenced by transmission times between the nodes.

For example, high performance artificial intelligence (AI) applications rely on high bandwidth network communication along with predictable tail latency. Congestion on the network directly affects the tail latencies and thereby affects the performance of the end applications.

### SUMMARY

A system of one or more computers may be configured to perform particular operations or actions by virtue of having software, firmware, hardware, or a combination of them installed on the system that in operation causes or cause the system to perform the actions. One or more computer programs may be configured to perform particular operations or actions by virtue of including instructions that, when executed by data processing apparatus, cause the apparatus to perform the actions.

One general aspect includes at least at least one computer readable storage medium comprising a set of instructions, which when executed by a computing device, cause the computing device to identify a message that is to be transmitted across a network, divide the message into a plurality of portions that are arranged in a first order, and generate a plurality of packets based on the plurality of portions. The set of instructions, which when executed by the computing device, causes the computing device to map different network paths for the plurality of packets to be transmitted to a destination, sets headers of the plurality of packets to represent the first order and the different network paths, transmits the plurality of packets over the network in an out-of-order fashion to the destination based on the headers, and arranges the plurality of transmitted packets into the first order based on the headers of the plurality of packets. Other examples of this aspect include corresponding computer systems, apparatus, and computer programs recorded on one or more computer storage devices, each configured to perform the actions described above.

One general aspect includes a system that includes one or more processors. The system also includes a memory coupled to the one or more processors, the memory may include instructions executable by the one or more processors, the one or more processors being operable when executing the instructions to identify a message that is to be transmitted across a network, divide the message into a plurality of portions that are arranged in a first order, generate a plurality of packets based on the plurality of portions and map different network paths for the plurality of packets to be transmitted to a destination. The one or more processors are further operable when executing the instructions to set headers of the plurality of packets to represent the first order and the different network paths, transmit the plurality of packets over the network in an out-of-order fashion to the destination based on the headers, and arrange the plurality of transmitted packets into the first order based on the headers of the plurality of packets. Other examples of this aspect include corresponding computer systems, apparatus, and computer programs recorded on one or more computer storage devices, each configured to perform the actions described above.

One general aspect includes a method that includes identifying a message that is to be transmitted across a network, dividing the message into a plurality of portions that are arranged in a first order, generating a plurality of packets based on the plurality of portions and mapping different network paths for the plurality of packets to be transmitted to a destination. The method also includes setting headers of the plurality of packets to represent the first order and the different network paths, transmitting the plurality of packets over the network in an out-of-order fashion to the destination based on the headers, and arranging the plurality of transmitted packets into the first order based on the headers of the plurality of packets. Other examples of this aspect include corresponding computer systems, apparatus, and computer programs recorded on one or more computer storage devices, each configured to perform the actions of the method.

### BRIEF DESCRIPTION OF THE DRAWINGS

The various advantages of the examples will become apparent to one skilled in the art by reading the following specification and appended claims, and by referencing the following drawings, in which:

FIGS. 1A and 1B illustrate a networked computing architecture according to an example of the disclosure;

FIG. 2 is a flowchart of an example of a method to transmit remote direct memory access messages according to an example of the disclosure;

FIG. 3 illustrates a computing architecture according to an example of the disclosure;

FIG. 4 illustrates a high level process to generate network and path identifications according to an example of the disclosure;

FIG. 5 illustrates a networking architecture according to an example of the disclosure;

FIG. 6 illustrates an example network environment associated with a social-networking system according to an example of the disclosure;

FIG. 7 illustrates an example social graph according to an example of the disclosure; and

FIG. 8 illustrates an example computer system according to an example of the disclosure.

### DESCRIPTION EXAMPLE

Examples of the disclosure relate to a network architecture that is able to transmit packets in an out-of-order fashion to facilitate low latency operations while also allocating networking resources more effectively than conventional network environments. The transmission of packets in an out-of-order fashion permits different packets to be transmitted along different network paths to allocate the packets to network paths that have available compute resources. Furthermore, transmitting the packets in the out-of-order fashion may avoid negative impacts from in-order transmission where all the network packets are transmitted along one network path resulting in overloading the network path and increasing latency while also underutilizing other network paths that have available network resources. Thus, examples as described herein enhance computer related technology or technical fields relating to network communications, artificial intelligence (e.g., machine learning) and remote direct memory access (RDMA) applications. Thus, implementations described herein are deeply rooted in computer technology and solve problems particular to computing architectures.

Several technical aspects facilitate implementation of the above. To implement the above, examples identify a message that is to be transmitted across a network, divide the message into a plurality of portions that are arranged in a first order, generate a plurality of packets based on the plurality of portions, map different network paths for the plurality of packets to be transmitted to a destination, set headers of the plurality of packets to represent the first order and the different network paths, transmit the plurality of packets over the network in an out-of-order fashion to the destination based on the headers, and arrange the received packets into the first order based on the headers of the plurality of packets. Doing so permits the message to be divided into smaller portions that are transmittable separately from each other as packets enabling out-of-order data transmission to a destination device. Furthermore, setting the headers to represent the first order enables the destination device to receive the packets in the out-of-order fashion, and then rearrange the packets to be in the first order to recreate the original message.

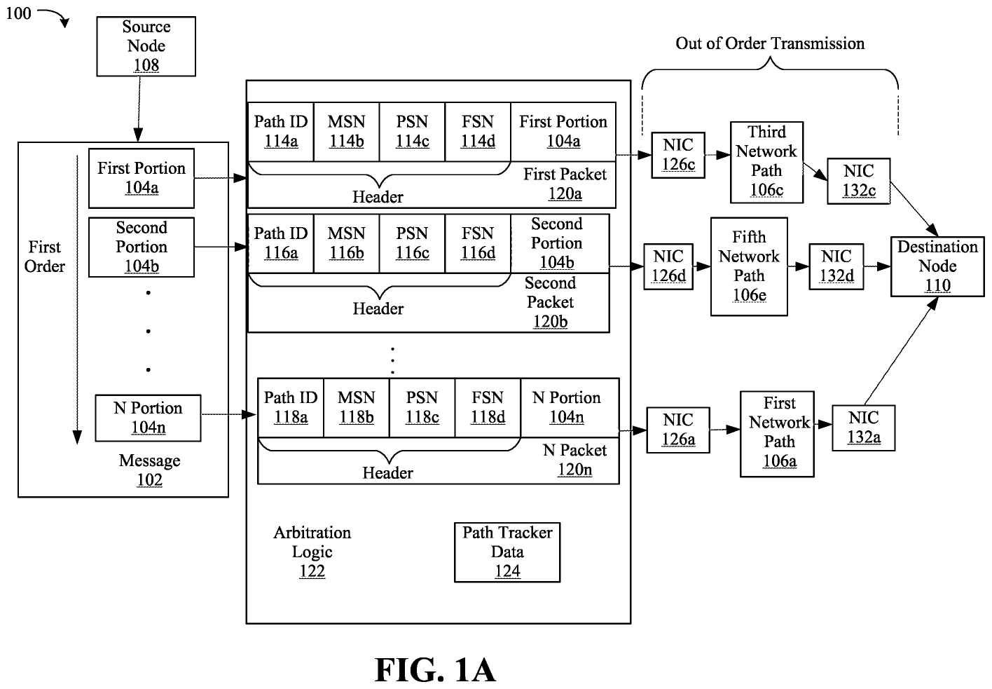

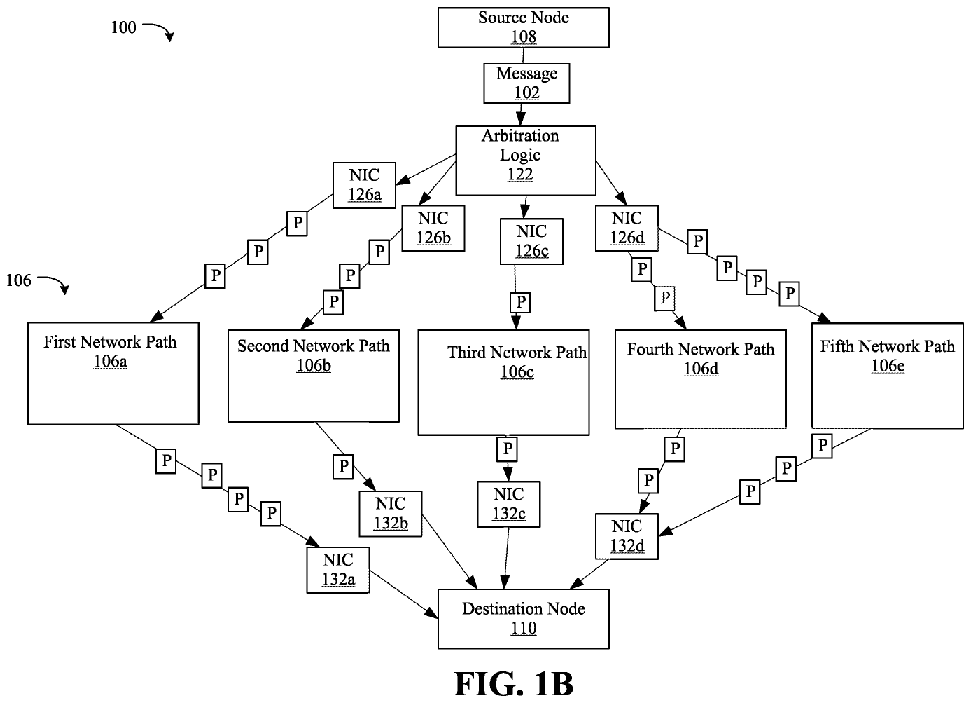

Turning now to FIGS. 1A and 1B, a networked computing architecture 100 is illustrated. The networked computing architecture 100 may be implemented in a computing device including a memory and processor, computing system (e.g., hardware, configurable logic, fixed-function logic hardware, at least one computer readable storage medium comprising a set of instructions for execution, etc.).

A message 102 is to be transmitted from a source node 108 to a destination node 110. As noted above, examples herein transmit first-N portions 104a-104n of the message 102 in an out-of-order fashion to facilitate a low latency transfer.

As illustrated in FIG. 1B, a plurality of paths 106 are configured between the destination node 110 and the source node 108 (e.g., communicating nodes). That is, a first network path 106a, second network path 106b, third network path 106c, fourth network path 106d and fifth network path 106e are formed between the source node 108 and the destination node 110. The source node 108 may provide a message 102 to the arbitration logic 122 that generates packets. The packets are transmitted over the plurality of paths 106 through the network interface cards (NICs) 126a, 126b, 126c, 126d. In some examples the NICs 126a, 126b, 126c, 126d may be merged into a single NIC that supports multiple data paths. Each of the 126a, 126b, 126c, 126d may have an egress port and traffic class. The plurality of paths 106 are dynamically added (e.g., new paths may be created when new elements are added and/or malfunctioning hardware is repaired) or removed (e.g., malfunctioning hardware makes the path unusable) based on network events. The plurality of paths 106 may include different hardware components (e.g., switches, hubs, cables, routers, wired links, wireless links, etc.).

Each NIC of the NICs 126a, 126b, 126c, 126d may contain a local view of the switches routing policy (e.g., hash table, lookup table, equal cost multi-path table (ECMP), etc.) and may define the resultant data path. Traffic engineering and overlay networks may define physical paths mapped to the logical paths.

The source node 108 and the destination node 110 may communicate with an RDMA process. RDMA is a way of moving buffers between two applications across a network. RDMA differs from traditional network interfaces because RDMA facilitates direction communication to bypass operating system(s) (e.g., software stacks). RDMA allows two networked computers to exchange data in main memory without relying on processors, caches or operating systems of either computer. This allows programs that implement RDMA to have low latency transfers, highest throughput and a small hardware (e.g., central processing unit) footprint. The NICs 126a-126d, 132a-132d implement an RDMA engine that may be shared by the 126a-126d, 132a-132d, although more than one RDMA engine may be implemented depending on the configuration. Queue pairs (QPs) contain a send and a receive queue. The send queue sends outbound messages requesting for the RDMA operations and are part of the source node 108. The receive queue receives incoming messages or immediate data and is part of the destination node 110. The NICs 126a-126d, 132a-132d may facilitate communication between the QPs.

For example, a source queue in the source node 108 may communicate with a destination queue in the destination node 110 as a QP. Similarly, other QPs may exist and communicate over the plurality of network paths 106 and the NICs 126a-126d, 132a-132d. Equation 1 may provide the rate for each queue pair:

$$Advertised Rate ( Mbps ) = NIC Speed ( Mbps ) / Active Queue Pair Count \qquad Equation 1$$

Equation 1 relates to a receiver based traffic scheduling process. A packet including the advertised rate is then sent out to all active QPs which comply with advertised rate. The advertised rate may be a usable bandwidth. In the above, the NIC speed is the speed of a network interface card under consideration of the NICs 12a-126d, 132a-132d. The active queue pair count is the number of active QPs that operate with the NIC under consideration in Equation 1. The rates are maintained by a QP transmit pacing arbitration logic that is above the path arbitration. As will be explained below, arbitration logic 122 (FIG. 1) may analyze characteristics (e.g., metrics) of the plurality of paths 106 to determine how many packets may be generated from the message 102, and how to distribute the packets across the plurality of paths 106.

The traffic (represented by packets P) between the source node 108 and the destination node 110 may not be equally distributed. The sum total of bandwidth allocated across all the paths of the plurality of paths 106 may be equal to a number as determined by the receiver based traffic scheduling process and Equation 1. A packet including the advertised rate is then sent out to all active QPs which comply with advertised rate. For example, the receiver based traffic scheduling process may adjust the allocated bandwidth for each data transfer based on a total number of queue pairs associated with an RDMA process and the sum total of bandwidth.

Initially, the source node 108 may generate the message 102. The message 102 may include first-N portions 104a-104n that represent different parts of the message 102. The message 102 may be associated with an AI/ML application, and may include data related to an Allreduce operation for example.

The first-N portions 104a-104n may be collectively represent the message 102 and are arranged in a first order. For example, the first portion 104a may be a first part of the message 102, the second portion 104b may be a second part of the message 102 that directly follows the first portion 104a and so forth. For example, the first-N portions 104a-104n may need to be arranged according to the first order to accurately represent the message 102. Otherwise, if the first-N portions 104a-104n are not arranged in the first order, the message 102 may not be accurately represented causing data errors and potentially causing application failures.

In this example, the arbitration logic 122 may divide the message 102 into the first-N portion 104a-104n to facilitate transmission of the message 102. For example, the message 102 may be too large to be transmitted at once, and/or may be more efficiently transported in discrete parts. Thus, the message 102 is divided into the first-N portion 104a-104n for transmission which are arranged in the first order.

In some examples, the arbitration logic 122 may divide the message 102 into the first-N portions 104a-104n based on characteristics (e.g., bandwidth, number of available paths, etc.) of the plurality of paths 106 that are stored in the path tracker data 124. Each of the first-N portions 104a-104n may be individually transmitted to the destination node 110 as part of a packet of the first packet 102a-120n. In some examples, each respective path of the plurality of paths 106 includes a dedicated path tracker that tracks characteristics/metrics of the respective path.

That is, the path tracker data 124 may include characteristics of the plurality of paths. The arbitration logic 122 may refer to the path tracker data 124 to allocate first-N packets 120a-120n to the first-fifth network paths 106a-106e. That is, the first-N packets 120a-120n are transmitted in an out-of-order fashion over different network paths of the first-fifth network paths 106a-106e to execute RDMA processes.

For example, the arbitration logic 122 may generate the traffic distribution across the configured paths based on “weights” that are dynamically derived by monitoring the network conditions of the plurality of paths 106 based on the path tracker data 124.

The arbitration logic 122 provides the load balancing functionality on the plurality of paths 106 with every packet being assigned a different “Network PathId” or as shown in FIG. 1A, Path ID 114a-Path ID 118a. Each of the path IDs 114a and 116a-118a are represented with a unique five tuple where some fields are mutable and others remain constant for a given pair of communicating nodes, such as the source node 108 and the destination node 110. An example of a mutable header fields includes a “udp.srcport field” which specifies a destination IP address (or multiple addresses) and the source ports associated with the destination addresses to use when making some types of connections. Another mutable header field includes IP flow label which is a flow label assigned to a flow of data packets associated with a common task or message. Another mutable header field includes Multiprotocol Label Switching (MPLS) tags, where MPLS is a routing technique in networks that directs data from one node to the next based on labels rather than network addresses. Any other type of arbitrary data fields may be further inserted into each packet (e.g., in the header) as well that drives the arbitration logic 122. For example, the arbitration logic 122 may analyze the header fields and/or the data fields of a respective packet to determine the path of the respective packet. That is, the “udp.srcport field” identifies a path of the respective path from the first-fifth network paths 106a-106e for the respective packet to be transmitted. Other header fields and/or data fields may be similarly used to determine the respect path.

The header fields and/or the data fields may represent the switches routing policy (e.g., routing table, hash table, lookup table, equal cost multi-path table (ECMP). For example, the header fields and/or the data fields may be set to match the switches routing policy (e.g., routing table) to follow switches along a path represented in the switches routing policy.

As noted above, for arbitration purposes, each of the plurality of paths 106 may have a collection of statistics and policy rules (quality-of-service, access controls, etc.) based on which path of the plurality of paths 106 is selected for every packet. Furthermore, a number of packets may be selected based on the collection of statistics and policy rules. The arbitration logic 122 uses a two level arbitration scheme. The first level determines which paths from the plurality of paths 106 are eligible for sending traffic and the second level selects a path number among the list of eligible paths for transmission. The first level of the arbitration scheme may detect whether paths from the plurality of paths 106 are unavailable, not functioning, etc. The second level of the arbitration scheme may select a path that has the capacity to handle another packet without exceeding bandwidth limitations and while meeting latency constraints.

The arbitration logic 122 (e.g., a QP transmit pacing arbitration logic) determines a number of packet segments to be created and scheduled and assigns different header fields. For example, the arbitration logic 122 may assign message Sequence Number (MSN) to each packet of the first-N packets 120a-120n. The MSN indicates the message number for the data, such as the first portion 104a-N portion 104n, sent between the source node 108 and the destination node 110. On the network transmit, the MSN is provided in a work descriptor (representing a destination). The work descriptor may be set by an application with instructions relating to initiating a data transfer to the destination node 110 (e.g., a label of where to send data). The application may generate the data. All the packets that are segmented from the given work descriptor will carry the same number. In this example, the MSNs 114b, 116b, 118b, etc. will be the same since the first portion 104a-N portion 104n relate to the same message 102. At the destination node 110, the MSN will be used to derive a base address used for writing received network data of maximum transmission unit (MTU) sized packets into a memory of the destination node 110. That is, the destination node 110 will utilize the MSNs 114b, 116b, 118b, etc. to determine where to store the first-N portions 104a-104n.

The arbitration logic 122 generates a Packet Offset Sequence Numbers (PSNs) 114c, 116c, 118c, etc. The PSN 114c, 116c, 118c, etc. indicates a respective packet offset within the message 102. The start number for the packet offset is provided by software as part of the work descriptor. At the network transmit, the PSN 114c, 116c, 118c, etc. is incremented by hardware segmentation logic and inserted into the first-N packet 120a-120n headers. The PSN 114c, 116c, 118c, etc. indicates an offset in the message that is used by the destination node 110 for data reassembly of the first-N portions 104a-104n. The destination node 110 uses the offset for deriving the segment address to write the data into the memory. The memory address for the data segments is derived as follows in Equation 2:

$$Memory address = BaseAddress + PSN \qquad Equation 2$$

In Equation 2, the base address is derived from and/or is the MSN 114b, 116b, 118b, etc. of a respective packet of the first-N packets 120a-120n. The PSN 114c, 116c, 118c, etc. as noted above is the offset of the respective packet and is reflected in the “PSN” of equation 2. Thus, the Equation 2 is repeatedly applied to each packet of the packets 120a-120n to determine a memory location to store the first portion 104a-N portion 104n.

For example, the destination node 110 may add the MSN 114b to the PSN 114c to determine a first memory location to store the first portion 104a of the first packet 120a. The destination node 110 may add the MSN 116b to the PSN 116c to determine a second memory location to store the second portion 104b of the second packet 120b. The first and second memory locations are different from each other to avoid overwriting memory. Each of the first-N packets 120a-120n is stored in a unique memory location. The first and second memory locations may be consecutively arranged to each other to comply with the first order in which the first and second portions 104a, 104b are consecutively arranged. In some examples, the MSNs 114b, 116b, 118b, etc. are the same as each other, while the FSNs 114d, 116d, 118d etc. are different from each other.

The arbitration logic 122 further generates a per Path Flowlet Sequence Number (FSN) 114d, 116d, 118d, etc. The FSN 114d, 116d, 118d, etc. is a monotonically incremented number per path as chosen by the destination node 110. The FSN 114d, 116d, 118d, etc. is used for data retransmissions and acknowledgments on the network. On the network transmit, once a path is chosen by the arbitration logic 122, the FSN 114d, 116d, 118d, etc. is assigned to a respective packet of the first packet 120a-N packet 120n. Hardware packet trackers keep track of this sequence number and manage the acknowledgements and any data loss recovery. For example, the source node 108 may include the hardware packet trackers. If an acknowledgement is not received for a particular packet that was transmitted on a network path, the packet may be retransmitted along a different network path.

The destination node 110 (e.g., a network receiver) may generate acknowledgement and negative acknowledgements based on the FSNs 114d, 116d, 118d, etc. For example, if an error is detected in a received packet, the destination node 110 discards the packet and sends a negative acknowledgement to the source node 108, and requests a re-transmission of the received packet. The FSNs 114d, 116d, 118d, etc. also indicates the windowing and credits maintained at the destination node 110 (e.g., receiving node) for accepting or rejecting incoming packets. Each path of the plurality of paths 106 may thus be assigned a unique FSN. Credits may be associated with each FSN to determine how many packets are on a respective path associated with the FSN. Thus, each packet of the first-N packets 120a-120n will be assigned a per path sequence number (e.g., FSN) based on a path selection assigned by the arbitration logic 122.

As described above, the arbitration logic 122 may select paths of the plurality of paths 106 to spray the first-N packets 120a-120n. To do so, characteristics of the plurality of paths 106 may be analyzed as described below.

Some examples maintain statistics per path of the plurality of paths 106. The arbitration logic 122 may analyze the statistics to determine how to distribute first-N packet 120a-120n. In order to determine the eligibility of a network path the first level arbitration scans through a number of Explicit Congestion Notifications (ECNs) and/or Congestion Notification Packet (CNPs) received by the source node 108 and/or the arbitration logic 122. Any ECN/CNP packet received will be sent to a transport engine. The transport engine keeps track of the counters and programs control-registers within the arbitration logic 122. Each ECN/CNP packet will indicate congestion conditions for an associated path of the plurality of paths. Counters associated with the paths may be incremented each time an ECN/CNP packet associated the paths is received. For example, if an ECN/CNP packet indicates that the first network path 106a is congested, a counter for the first network path 106a may be incremented. The ECN/CNP data may be stored as part of the path tracker data 124. Any path of the plurality of paths 106 that has a number of ECN/CNP packets above a threshold may be excluded.

Some examples further review the keep alive status of the plurality of paths 106. Transport engine may periodically check the health and/or status of the connectivity of each of the plurality of paths 106 and maintains a keep alive status if the connectivity is validated. This keep alive status will be used as a criteria for eligibility of the path for the second level arbitration. If a respective path of the plurality of paths 106 has a disconnected status (e.g., respective path is broken) and/or is unresponsive to keep alive messages, the respective path may be excluded from further consideration (e.g., will not be selected to transmit any packets).

For example, keep alive messages are periodically sent between the source node 108 and the destination node 110 across the plurality of paths 106 to check that each of the plurality of paths 106 is functioning and able to carry messages. If one or more paths of the plurality of paths 106 are unresponsive for a period of time as indicated by the lack of response to the keep alive messages, the arbitration logic 122 removes the one or more paths from a path-arbitration list and the one or more paths are automatically excluded from being selected to carry any packets from the source node 108 to the destination node 110. Doing so detects network black holes while maintaining desired performance metrics. A network black hole is when a packet traversing a network drops off and cannot be detected. The keep alive messages facilitate detection of failure scenarios such as topology change, link failures, switch failures, etc. The path-arbitration may now fail-over an existing path onto a new logical path mapping which takes an alternate route to preserve the allocated bandwidth.

In some examples, the arbitration logic 122 further executes a local credits and first-in-first-out (FIFO) space available analysis. One of more paths of the plurality of paths 106 may be mapped to an egress port of the NICs 126a-126d, and traffic class on the NICs 126a-126d. Each of the plurality of paths 106 has buffers at a Media Access Control (MAC) interface of the NICs 126a-126d to absorb a priority flow control (PFC) back pressures from switches of the plurality of paths 106. If the egress port and/or traffic class (TC) of a respective NIC of the NICs 126a-126d is paused, the respective NIC and associated path of the plurality of paths 106 will not be eligible for path selection. For example, if the egress port and/or traffic class (TC) of the NIC 126b is paused, the second network path 106b may be excluded from further consideration.

In some examples, the arbitration logic 122 may further utilize remote credits to determine whether to select a path from the plurality of paths 106. Remote credits reflect space available at the destination node 110 and/or NICs 132a-132d. The remote credits may be communicated through control messages and may reflect the resources of the destination node 110 and/or NICs 132a-132d (e.g., receivers) to absorb data through a given network path of the plurality of paths 106. For example, the remove credits may indicate whether each of the NICs 132a-132d have available resources to process further packets.

In some examples, the arbitration logic 122 may further utilize tracker space to determine whether to select a path from the plurality of paths 106. Packet trackers are used for tracking a packet per path and issuing retransmissions in the event of data loss. If a specific path of the plurality of paths 106 encounters excessive data losses (e.g., due to congestion or errors) such data losses will be reflect as a lack of space in the packet trackers. The tracker space reflects the window of packets that are outstanding in the network and along the plurality of paths 106. Based on the available space in the tracker space the following information may be derived and is used by the arbitration logic 122 to select a path from the plurality of paths 106.

First, a number of inflight packets and yet to be acknowledged packets may be derived from the tracker space. Secondly, a number of packets retransmitted due to negative acknowledgements from the destination node 110 may be derived from the tracker space. Such retransmitted packets represent packet drops either due to congestion on the plurality of paths 106 or drops due to link level errors. Contiguous packet drops on a particular path of the plurality of paths 106 may be due to congestion related issues on the particular path. If such a situation arises, the particular path is not selected for further packets.

As the acknowledgements and non-acknowledgements are managed per path, the round trip time (RTT) may be determined. The RTT may be the time from scheduling a corresponding packet for transmission on a particular path of the plurality of paths 106 to receive an acknowledgment from the destination node 110 that the corresponding path is received. The RTT may be calculated and averaged over a period of time for several different packets. The maximum, minimum and the average RTT values are maintained per tracker and/or per path of the plurality of paths 106 basis. If one or more of the maximum RTT, minimum RTT, or average RTT of a particular path of the plurality of paths 106 reaches a threshold, the particular path may be excluded from receiving further packets. For example, if the maximum RTT reaches a maximum threshold, the particular path may be excluded and will not be assigned further packets. If the minimum RTT reaches a minimum threshold, the particular path may be excluded and will not be assigned further packets. If the average RTT reaches an average threshold, the particular path may be excluded and will not be assigned further packets.

In this example, the first packet 120a is set to be transmitted over the third network path 106c. Thus, the path ID 114a may represent the third network path 106c. The path ID 114a may be referenced during transit (e.g., by a switch or router) to determine where to route the first packet 120a. The second packet 120b is set to be transmitted over the fifth network path 106e. Thus, the path ID 116a may represent the fifth network path 106e. The path ID 116a may be referenced during transit (e.g., by a switch or router) to determine where to route the second packet 120b. The N packet 120n is set to be transmitted over the first network path 106a. Thus, the path ID 118a may represent the first network path 106a. The path ID 118a may be referenced during transit (e.g., by a switch or router) to determine where to route the N packet 120n.

Thus, the first packet 120a-N packet 120n may be transmitted to the destination node 110 in an out-of-order transmission (e.g., in parallel). Doing so may utilize compute resources of paths of the plurality of paths 106 that would otherwise remain idle and underutilized. The destination node 110 may reassemble the first-N packets 120a-120n as described above and based on header information.

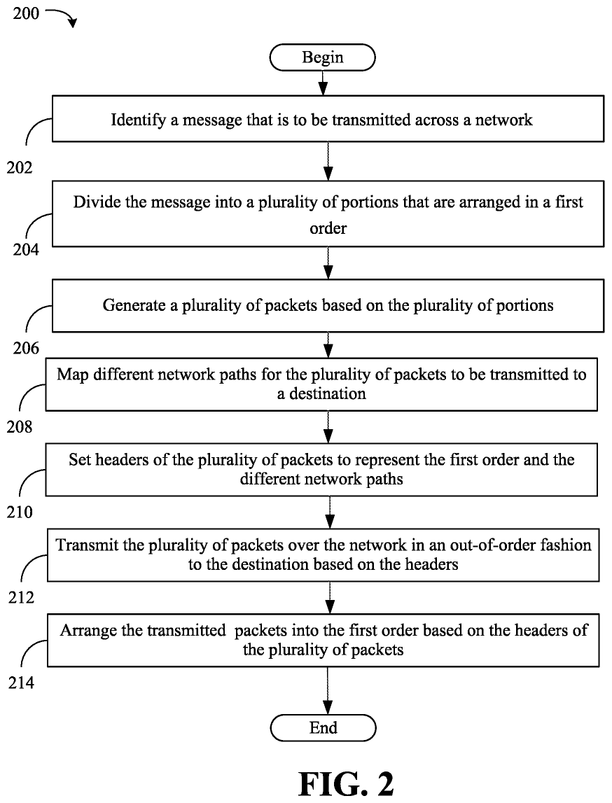

FIG. 2 illustrates a method 200 to transmit RDMA messages in an out-of-order fashion. One or more aspects of method 200 may be implemented as part of and/or in conjunction with networked computing architecture 100 (FIGS. 1A and 1B). Method 200 may be implemented in a computing device, computing system (e.g., hardware, configurable logic, fixed-function logic hardware, at least one computer readable storage medium comprising a set of instructions for execution, etc.).

Illustrated processing block 202 identifies a message that is to be transmitted across a network. Illustrated processing block 204 divides the message into a plurality of portions that are arranged in a first order. Illustrated processing block 206 generates a plurality of packets based on the plurality of portions. Illustrated processing block 208 maps different network paths for the plurality of packets to be transmitted to a destination. Illustrated processing block 210 sets headers of the plurality of packets to represent the first order and the different network paths. Illustrated processing block 212 transmits the plurality of packets over the network in an out-of-order fashion to the destination based on the headers. Illustrated processing block 214 arranges the transmitted packets into the first order based on the headers of the plurality of packets.

In some example, the method 200 further includes maintaining metrics for the different network paths. In some examples, first metrics of the metrics corresponds to a first network path of the different network paths, and the first metrics include one or more of an indication of whether the first network path is available or unavailable, a numbers of credits associated with different receivers of the destination, whether an egress port associated with the first network path is paused or an amount of data loss associated with the first network path.

In some examples, the headers of the packets include first fields indicating a message number of the message, packet offset numbers indicating packet offset within the message, and sequence numbers indicating numbers of respective paths of the different network paths assigned to the packets. In some examples, each of the packets includes a respective header of the headers, each of the headers include a network path identification that is a unique tuple representing a path of the different network paths assigned to a respective packet of the packets associated with the header, and the method 200 further includes routing each of the packets according to the network path identification in the header of the packet.

In some examples, the method 200 includes transmitting one or more keep alive messages over the different network paths to determine if the different network paths are responsive. In some examples, the message is associated with a remote direct memory access operation.

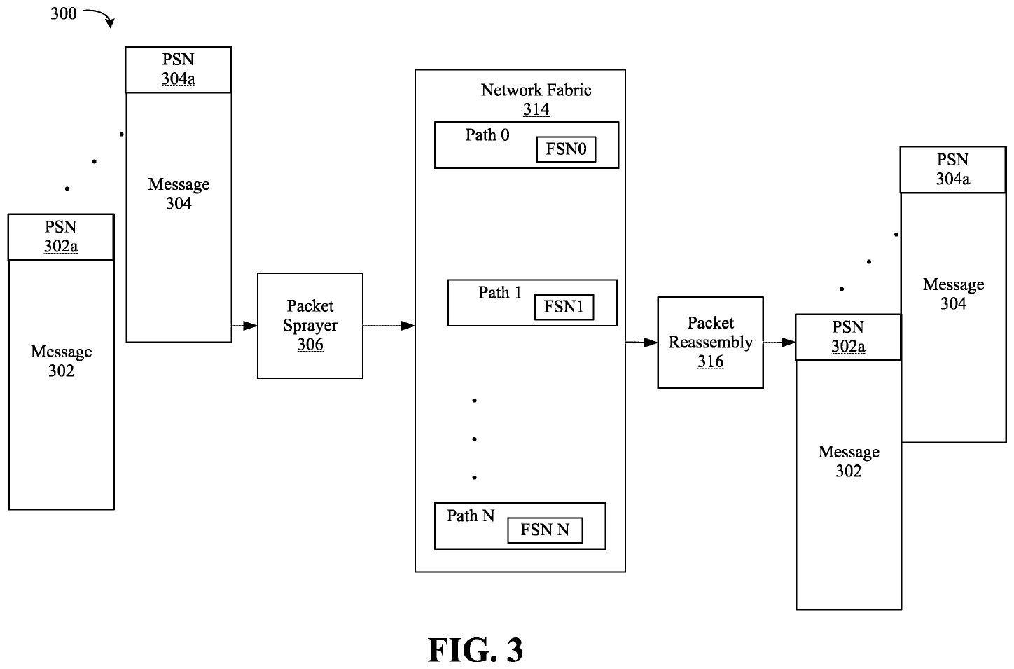

FIG. 3 illustrates a computing architecture 300 to distribute packets in an out-of-order fashion. One or more aspects the computing architecture 300 may be implemented as part of and/or in conjunction with networked computing architecture 100 (FIGS. 1A and 1B) and/or method 200 (FIG. 2). Computing architecture 300 may be implemented in a computing device, computing system (e.g., hardware, configurable logic, fixed-function logic hardware, at least one computer readable storage medium comprising a set of instructions for execution, etc.).

Initially messages 302-304 are provide. The messages 302-304 include PSNs 302a-304a and MSNs (not illustrated). A packet sprayer 306 distributes packets that represent the messages 302-304. In some examples, the packet sprayer 306 may operate in conjunction with arbitration logic, such as arbitration logic 122 (FIG. 1A) to transmit packets according to the arbitration logic 122 decisions.

Network fabric 314 includes path 0-path N. Each of the path 0-path N have unique FSNs. A packet reassembly 316 reassembles the packets into messages 302-304 (e.g., at a destination).

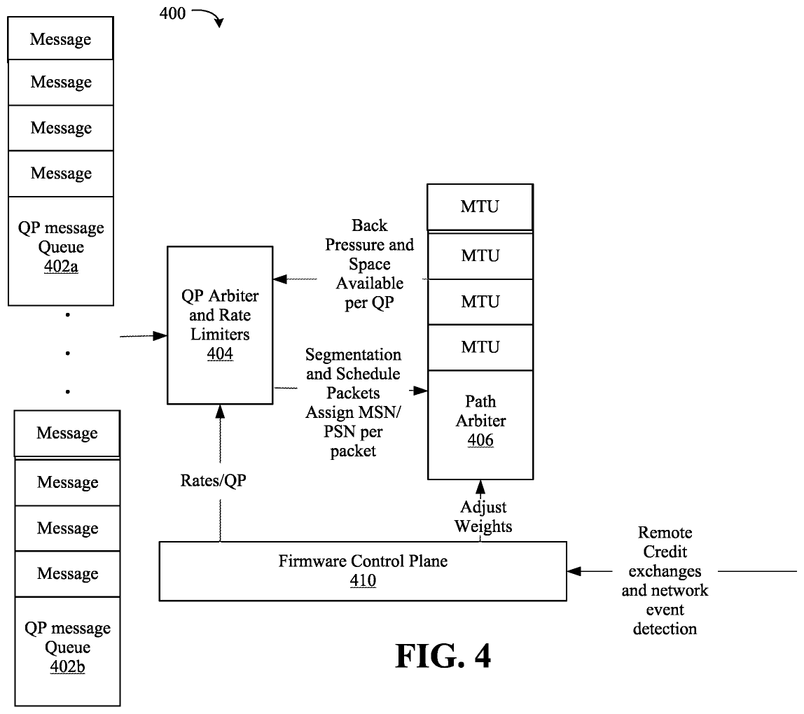

FIG. 4 illustrates a high level process 400 to generate a Network-PathID determination per packet. One or more aspects the high level process 400 may be implemented as part of and/or in conjunction with networked computing architecture 100 (FIGS. 1A and 1B), method 200 (FIG. 2) and/or computing architecture 300 (FIG. 3). Process 400 may be implemented in a computing device, computing system (e.g., hardware, configurable logic, fixed-function logic hardware, at least one computer readable storage medium comprising a set of instructions for execution, etc.).

The PathId is mapped into a unique five Tuple before the header encapsulation process. For example, a packet's five tuple is mapped into a PathId that is used as part of other transport processing.

The mapping tables are managed by a firmware control plane 410 (e.g., a control plane agent in the firmware). In this example, QP message queues 402a-402b maintain a plurality of messages that are to be transmitted. A QP arbiter and rate limiters 404 determines a segmentation for each of the messages to divide each of the messages into various portions that will be transmitted as packets. The QP arbiter and rate limiter 404 provides segmentation and schedule packets to assign MSN/PSN. The QP arbiter and rate limiters 404 receive back pressure and space available per QP from a path arbiter 406. A firmware control plane 410 provides rates/QP (e.g., bandwidth that the QP may utilize for each NIC) to the QP arbiter and rate limiters 404, and a command to adjust weights to the path arbiter 406. The weights may bias selections of the paths. The firmware control plane 410 receives remote credit exchanges and network event detection.

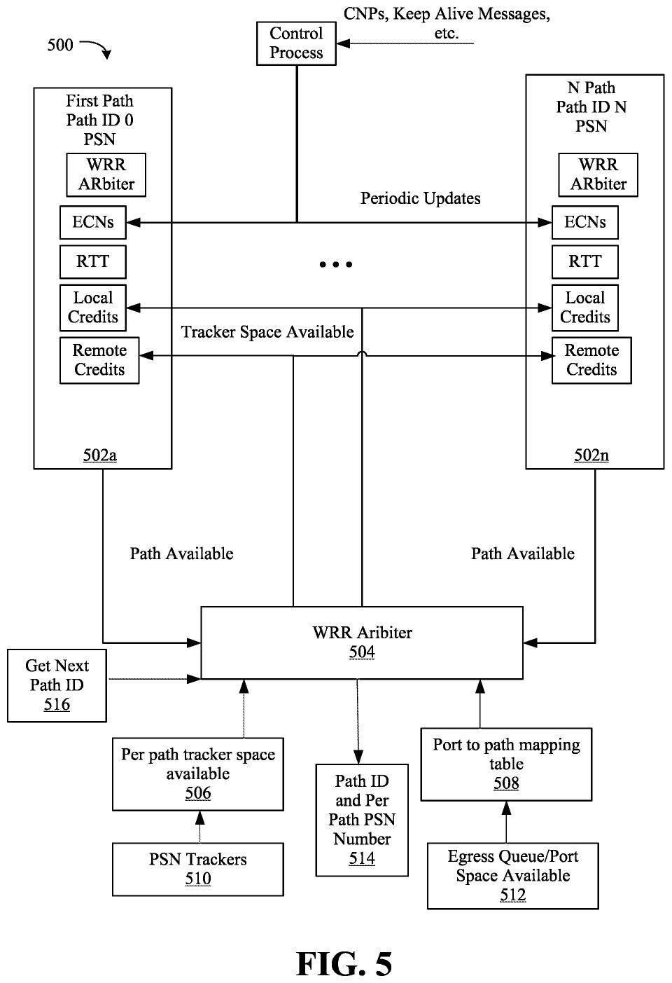

FIG. 5 illustrates a networking architecture 500. A control process receives CNPs, keep alive messages, and other networking tests and/or data to determine how to distribute packets. First path 502a has a unique path ID 0 along with specific and unique characteristics (e.g., ECNs, RTT, local credits, remote credits, etc.) which are generated and/or monitored by the first path 502a. Similarly, the remainder of the paths may include unique characteristics. An arbiter 504 (e.g., a weighted round robin (WWR) arbiter) receives the data from the paths 502a-502n. The arbiter 504 may receive a get next path ID 516, and outputs a path ID and per path PSN number 514 in response. The arbiter 504 also receives a per path tracker space available 506 from PSN trackers 510. The arbiter 504 further receives a port to path mapping table 508 that is based on egress queue/port space available 512.

### System Overview

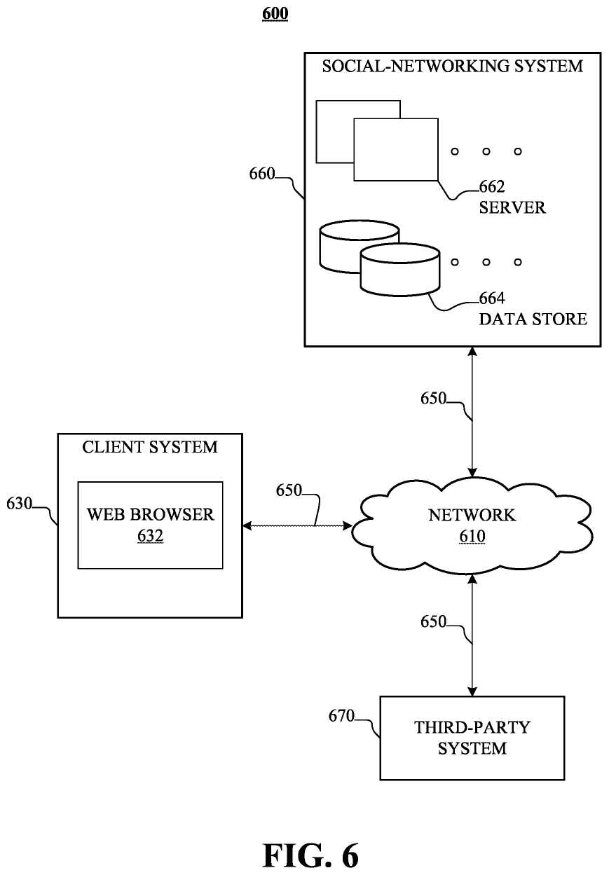

FIG. 6 illustrates an example network environment 600 associated with a social-networking system. Network environment 600 may implement one or more aspects of networked computing architecture 100 (FIGS. 1A and 1B), method 200 (FIG. 2), computing architecture 300 (FIG. 3) and/or process 400 (FIG. 4) and/or networking architecture 500 (FIG. 5) already discussed.

Network environment 600 includes a client system 630, a social-networking system 660, and a third-party system 670 connected to each other by a network 610. Although FIG. 6 illustrates a particular arrangement of client system 630, social-networking system 660, third-party system 670, and network 610, this disclosure contemplates any suitable arrangement of client system 630, social-networking system 660, third-party system 670, and network 610. As an example and not by way of limitation, two or more of client system 630, social-networking system 660, and third-party system 670 may be connected to each other directly, bypassing network 610. As another example, two or more of client system 630, social-networking system 660, and third-party system 670 may be physically or logically co-located with each other in whole or in part. Moreover, although FIG. 6 illustrates a particular number of client systems 630, social-networking systems 660, third-party systems 670, and networks 610, this disclosure contemplates any suitable number of client systems 630, social-networking systems 660, third-party systems 670, and networks 610. As an example and not by way of limitation, network environment 600 may include multiple client system 630, social-networking systems 660, third-party systems 670, and networks 610.

This disclosure contemplates any suitable network 610. As an example and not by way of limitation, one or more portions of network 610 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 610 may include one or more networks 610.

Links 650 may connect client system 630, social-networking system 660, and third-party system 670 to communication network 610 or to each other. This disclosure contemplates any suitable links 650. In particular examples, one or more links 650 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular examples, one or more links 650 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 650, or a combination of two or more such links 650. Links 650 need not necessarily be the same throughout network environment 600. One or more first links 650 may differ in one or more respects from one or more second links 650.

In particular examples, client system 630 may be an electronic device including hardware, software, or embedded logic components or a combination of two or more such components and capable of carrying out the appropriate functionalities implemented or supported by client system 630. As an example and not by way of limitation, a client system 630 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 630. A client system 630 may enable a network user at client system 630 to access network 610. A client system 630 may enable its user to communicate with other users at other client systems 630.

In particular examples, client system 630 may include a web browser 632, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 630 may enter a Uniform Resource Locator (URL) or other address directing the web browser 632 to a particular server (such as server 662, or a server associated with a third-party system 670), and the web browser 632 may generate a Hyper Text Transfer Protocol (HTTP) request and communicate the HTTP request to server. The server may accept the HTTP request and communicate to client system 630 one or more Hyper Text Markup Language (HTML) files responsive to the HTTP request. Client system 630 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular examples, social-networking system 660 may be a network-addressable computing system that may host an online social network. Social-networking system 660 may generate, store, receive, and send social-networking data, such as, for example, user-profile data, concept-profile data, social-graph information, or other suitable data related to the online social network. Social-networking system 660 may be accessed by the other components of network environment 600 either directly or via network 610. As an example and not by way of limitation, client system 630 may access social-networking system 660 using a web browser 632, or a native application associated with social-networking system 660 (e.g., a mobile social-networking application, a messaging application, another suitable application, or any combination thereof) either directly or via network 610. In particular examples, social-networking system 660 may include one or more servers 662. Each server 662 may be a unitary server or a distributed server spanning multiple computers or multiple datacenters. Servers 662 may be of various types, such as, for example and without limitation, web server, news server, mail server, message server, advertising server, file server, application server, exchange server, database server, proxy server, another server suitable for performing functions or processes described herein, or any combination thereof. In particular examples, each server 662 may include hardware, software, or embedded logic components or a combination of two or more such components for carrying out the appropriate functionalities implemented or supported by server 662. In particular examples, social-networking system 660 may include one or more data stores 664. Data stores 664 may be used to store various types of information. In particular examples, the information stored in data stores 664 may be organized according to specific data structures. In particular examples, each data store 664 may be a relational, columnar, correlation, or other suitable database. Although this disclosure describes or illustrates particular types of databases, this disclosure contemplates any suitable types of databases. Particular examples may provide interfaces that enable a client system 630, a social-networking system 660, or a third-party system 670 to manage, retrieve, modify, add, or delete, the information stored in data store 664.

In particular examples, social-networking system 660 may store one or more social graphs in one or more data stores 664. In particular examples, a social graph may include multiple nodes—which may include multiple user nodes (each corresponding to a particular user) or multiple concept nodes (each corresponding to a particular concept)—and multiple edges connecting the nodes. Social-networking system 660 may provide users of the online social network the ability to communicate and interact with other users. In particular examples, users may join the online social network via social-networking system 660 and then add connections (e.g., relationships) to a number of other users of social-networking system 660 to whom they want to be connected. Herein, the term “friend” may refer to any other user of social-networking system 660 with whom a user has formed a connection, association, or relationship via social-networking system 660.

In particular examples, social-networking system 660 may provide users with the ability to take actions on various types of items or objects, supported by social-networking system 660. As an example and not by way of limitation, the items and objects may include groups or social networks to which users of social-networking system 660 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 660 or by an external system of third-party system 670, which is separate from social-networking system 660 and coupled to social-networking system 660 via a network 610.

In particular examples, social-networking system 660 may be capable of linking a variety of entities. As an example and not by way of limitation, social-networking system 660 may enable users to interact with each other as well as receive content from third-party systems 670 or other entities, or to allow users to interact with these entities through an application programming interfaces (API) or other communication channels.

In particular examples, a third-party system 670 may include one or more types of servers, one or more data stores, one or more interfaces, including but not limited to APIs, one or more web services, one or more content sources, one or more networks, or any other suitable components, e.g., that servers may communicate with. A third-party system 670 may be operated by a different entity from an entity operating social-networking system 660. In particular examples, however, social-networking system 660 and third-party systems 670 may operate in conjunction with each other to provide social-networking services to users of social-networking system 660 or third-party systems 670. In this sense, social-networking system 660 may provide a platform, or backbone, which other systems, such as third-party systems 670, may use to provide social-networking services and functionality to users across the Internet.

In particular examples, a third-party system 670 may include a third-party content object provider. A third-party content object provider may include one or more sources of content objects, which may be communicated to a client system 630. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular examples, social-networking system 660 also includes user-generated content objects, which may enhance a user's interactions with social-networking system 660. User-generated content may include anything a user may add, upload, send, or “post” to social-networking system 660. As an example and not by way of limitation, a user communicates posts to social-networking system 660 from a client system 630. Posts may include data such as status updates or other textual data, location information, photos, videos, links, music or other similar data or media. Content may also be added to social-networking system 660 by a third-party through a “communication channel,” such as a newsfeed or stream.

In particular examples, social-networking system 660 may include a variety of servers, sub-systems, programs, modules, logs, and data stores. In particular examples, social-networking system 660 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 660 may also include suitable components such as network interfaces, security mechanisms, load balancers, failover servers, management-and-network-operations consoles, other suitable components, or any suitable combination thereof. In particular examples, social-networking system 660 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 660 to one or more client systems 630 or one or more third-party system 670 via network 610. The web server may include a mail server or other messaging functionality for receiving and routing messages between social-networking system 660 and one or more client systems 630. An API-request server may allow a third-party system 670 to access information from social-networking system 660 by calling one or more APIs. An action logger may be used to receive communications from a web server about a user's actions on or off social-networking system 660. In conjunction with the action log, a third-party-content-object log may be maintained of user exposures to third-party-content objects. A notification controller may provide information regarding content objects to a client system 630. Information may be pushed to a client system 630 as notifications, or information may be pulled from client system 630 responsive to a request received from client system 630. Authorization servers may be used to enforce one or more privacy settings of the users of social-networking system 660. A privacy setting of a user determines how particular information associated with a user may be shared. The authorization server may allow users to opt in to or opt out of having their actions logged by social-networking system 660 or shared with other systems (e.g., third-party system 670), such as, for example, by setting appropriate privacy settings. Third-party-content-object stores may be used to store content objects received from third parties, such as a third-party system 670. Location stores may be used for storing location information received from client systems 630 associated with users. Advertisement-pricing modules may combine social information, the current time, location information, or other suitable information to provide relevant advertisements, in the form of notifications, to a user.

### Social Graphs

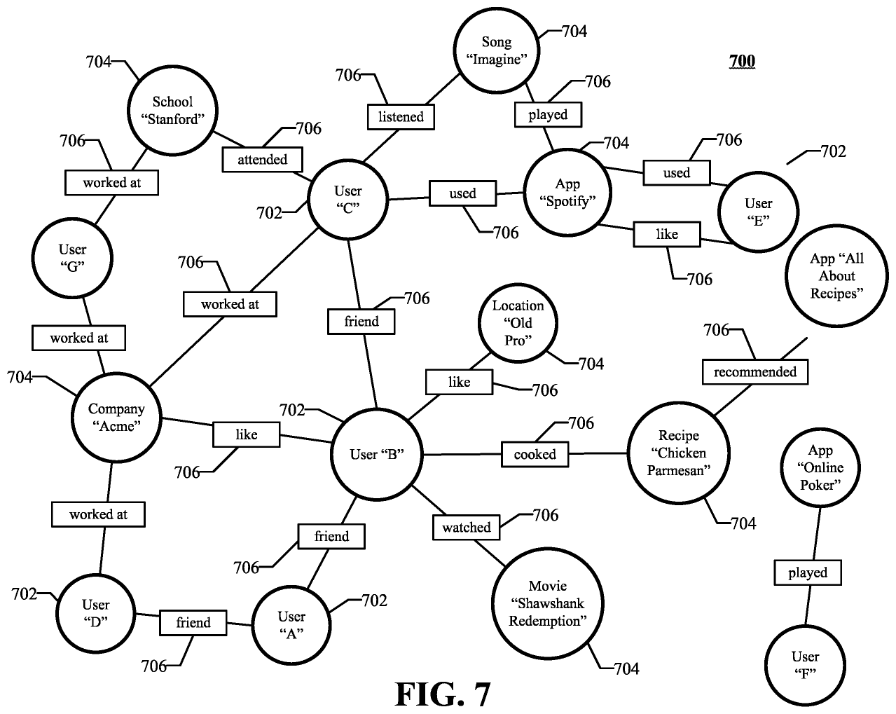

FIG. 7 illustrates example social graph 700. In some examples, networked computing architecture 100 (FIGS. 1A and 1B), method 200 (FIG. 2), computing architecture 300 (FIG. 3) and/or process 400 (FIG. 4) and/or networking architecture 500 (FIG. 5) already discussed may access social graph 700 to implement one or more aspects.

In particular examples, social-networking system 660 may store one or more social graphs 700 in one or more data stores. In particular examples, social graph 700 may include multiple nodes—which may include multiple user nodes 702 or multiple concept nodes 704—and multiple edges 706 connecting the nodes. Each node may be associated with a unique entity (i.e., user or concept), each of which may have a unique identifier (ID), such as a unique number or username. Example social graph 700 illustrated in FIG. 7 is shown, for didactic purposes, in a two-dimensional visual map representation. In particular examples, a social-networking system 660, client system 630, or third-party system 670 may access social graph 700 and related social-graph information for suitable applications. The nodes and edges of social graph 700 may be stored as data objects, for example, in a data store (such as a social-graph database). Such a data store may include one or more searchable or queryable indexes of nodes or edges of social graph 700.

In particular examples, a user node 702 may correspond to a user of social-networking system 660. As an example and not by way of limitation, a user may be an individual (human user), an entity (e.g., an enterprise, business, or third-party application), or a group (e.g., of individuals or entities) that interacts or communicates with or over social-networking system 660. In particular examples, when a user registers for an account with social-networking system 660, social-networking system 660 may create a user node 702 corresponding to the user, and store the user node 702 in one or more data stores. Users and user nodes 702 described herein may, where appropriate, refer to registered users and user nodes 702 associated with registered users. In addition or as an alternative, users and user nodes 702 described herein may, where appropriate, refer to users that have not registered with social-networking system 660. In particular examples, a user node 702 may be associated with information provided by a user or information gathered by various systems, including social-networking system 660. As an example and not by way of limitation, a user may provide his or her name, profile picture, contact information, birth date, sex, marital status, family status, employment, education background, preferences, interests, or other demographic information. In particular examples, a user node 702 may be associated with one or more data objects corresponding to information associated with a user. In particular examples, a user node 702 may correspond to one or more webpages.

In particular examples, a concept node 704 may correspond to a concept. As an example and not by way of limitation, a concept may correspond to a place (such as, for example, a movie theater, restaurant, landmark, or city); a website (such as, for example, a website associated with social-network system 660 or a third-party website associated with a web-application server); an entity (such as, for example, a person, business, group, sports team, or celebrity); a resource (such as, for example, an audio file, video file, digital photo, text file, structured document, or application) which may be located within social-networking system 660 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 704 may be associated with information of a concept provided by a user or information gathered by various systems, including social-networking system 660. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular examples, a concept node 704 may be associated with one or more data objects corresponding to information associated with concept node 704. In particular examples, a concept node 704 may correspond to one or more webpages.

In particular examples, a node in social graph 700 may represent or be represented by a webpage (which may be referred to as a “profile page”). Profile pages may be hosted by or accessible to social-networking system 660. Profile pages may also be hosted on third-party websites associated with a third-party system 670. As an example and not by way of limitation, a profile page corresponding to a particular external webpage may be the particular external webpage and the profile page may correspond to a particular concept node 704. Profile pages may be viewable by all or a selected subset of other users. As an example and not by way of limitation, a user node 702 may have a corresponding user-profile page in which the corresponding user may add content, make declarations, or otherwise express himself or herself. As another example and not by way of limitation, a concept node 704 may have a corresponding concept-profile page in which one or more users may add content, make declarations, or express themselves, particularly in relation to the concept corresponding to concept node 704.

In particular examples, a concept node 704 may represent a third-party webpage or resource hosted by a third-party system 670. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 630 to send to social-networking system 660 a message indicating the user's action. In response to the message, social-networking system 660 may create an edge (e.g., a check-in-type edge) between a user node 702 corresponding to the user and a concept node 704 corresponding to the third-party webpage or resource and store edge 706 in one or more data stores.

In particular examples, a pair of nodes in social graph 700 may be connected to each other by one or more edges 706. An edge 706 connecting a pair of nodes may represent a relationship between the pair of nodes. In particular examples, an edge 706 may include or represent one or more data objects or attributes corresponding to the relationship between a pair of nodes. As an example and not by way of limitation, a first user may indicate that a second user is a “friend” of the first user. In response to this indication, social-networking system 660 may send a “friend request” to the second user. If the second user confirms the “friend request,” social-networking system 660 may create an edge 706 connecting the first user's user node 702 to the second user's user node 702 in social graph 700 and store edge 706 as social-graph information in one or more of data stores 664. In the example of FIG. 7, social graph 700 includes an edge 706 indicating a friend relation between user nodes 702 of user “A” and user “B” and an edge indicating a friend relation between user nodes 702 of user “C” and user “B.” Although this disclosure describes or illustrates particular edges 706 with particular attributes connecting particular user nodes 702, this disclosure contemplates any suitable edges 706 with any suitable attributes connecting user nodes 702. As an example and not by way of limitation, an edge 706 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 700 by one or more edges 706. The degree of separation between two objects represented by two nodes, respectively, is a count of edges in a shortest path connecting the two nodes in the social graph 700. As an example and not by way of limitation, in the social graph 700, the user node 702 of user “C” is connected to the user node 702 of user “A” via multiple paths including, for example, a first path directly passing through the user node 702 of user “B,” a second path passing through the concept node 704 of company “Acme” and the user node 702 of user “D,” and a third path passing through the user nodes 702 and concept nodes 704 representing school “Stanford,” user “G,” company “Acme,” and user “D.” User “C” and user “A” have a degree of separation of two because the shortest path connecting their corresponding nodes (i.e., the first path) includes two edges 706.

In particular examples, an edge 706 between a user node 702 and a concept node 704 may represent a particular action or activity performed by a user associated with user node 702 toward a concept associated with a concept node 704. As an example and not by way of limitation, as illustrated in FIG. 7, a user may “like,” “attended,” “played,” “listened,” “cooked,” “worked at,” or “watched” a concept, each of which may correspond to an edge type or subtype. A concept-profile page corresponding to a concept node 704 may include, for example, a selectable “check in” icon (such as, for example, a clickable “check in” icon) or a selectable “add to favorites” icon. Similarly, after a user clicks these icons, social-networking system 660 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 660 may create a “listened” edge 706 and a “used” edge (as illustrated in FIG. 6) between user nodes 702 corresponding to the user and concept nodes 704 corresponding to the song and application to indicate that the user listened to the song and used the application. Moreover, social-networking system 660 may create a “played” edge 706 (as illustrated in FIG. 6) between concept nodes 704 corresponding to the song and the application to indicate that the particular song was played by the particular application. In this case, “played” edge 706 corresponds to an action performed by an external application (SPOTIFY) on an external audio file (the song “Imagine”). Although this disclosure describes particular edges 706 with particular attributes connecting user nodes 702 and concept nodes 704, this disclosure contemplates any suitable edges 706 with any suitable attributes connecting user nodes 702 and concept nodes 704. Moreover, although this disclosure describes edges between a user node 702 and a concept node 704 representing a single relationship, this disclosure contemplates edges between a user node 702 and a concept node 704 representing one or more relationships. As an example and not by way of limitation, an edge 706 may represent both that a user likes and has used at a particular concept. Alternatively, another edge 706 may represent each type of relationship (or multiples of a single relationship) between a user node 702 and a concept node 704 (as illustrated in FIG. 7 between user node 702 for user “E” and concept node 704 for “SPOTIFY”).

In particular examples, social-networking system 660 may create an edge 706 between a user node 702 and a concept node 704 in social graph 700. As an example and not by way of limitation, a user viewing a concept-profile page (such as, for example, by using a web browser or a special-purpose application hosted by the user's client system 630) may indicate that he or she likes the concept represented by the concept node 704 by clicking or selecting a “Like” icon, which may cause the user's client system 630 to send to social-networking system 660 a message indicating the user's liking of the concept associated with the concept-profile page. In response to the message, social-networking system 660 may create an edge 706 between user node 702 associated with the user and concept node 704, as illustrated by “like” edge 706 between the user and concept node 704. In particular examples, social-networking system 660 may store an edge 706 in one or more data stores. In particular examples, an edge 706 may be automatically formed by social-networking system 660 in response to a particular user action. As an example and not by way of limitation, if a first user uploads a picture, watches a movie, or listens to a song, an edge 706 may be formed between user node 702 corresponding to the first user and concept nodes 704 corresponding to those concepts. Although this disclosure describes forming particular edges 706 in particular manners, this disclosure contemplates forming any suitable edges 706 in any suitable manner.

### Social Graph Affinity and Coefficient

In particular examples, social-networking system 660 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 670 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular examples, social-networking system 660 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular examples, social-networking system 660 may use a variety of factors to calculate a coefficient. These factors may include, for example, user actions, types of relationships between objects, location information, other suitable factors, or any combination thereof. In particular examples, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular examples, the social-networking system 660 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular examples, social-networking system 660 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular examples, social-networking system 660 may calculate a coefficient based on a user's actions. Social-networking system 660 may monitor such actions on the online social network, on a third-party system 670, on other suitable systems, or any combination thereof. Any suitable type of user actions may be tracked or monitored. Typical user actions include viewing profile pages, creating or posting content, interacting with content, tagging or being tagged in images, joining groups, listing and confirming attendance at events, checking-in at locations, liking particular pages, creating pages, and performing other tasks that facilitate social action. In particular examples, social-networking system 660 may calculate a coefficient based on the user's actions with particular types of content. The content may be associated with the online social network, a third-party system 670, or another suitable system. The content may include users, profile pages, posts, news stories, headlines, instant messages, chat room conversations, emails, advertisements, pictures, video, music, other suitable objects, or any combination thereof. Social-networking system 660 may analyze a user's actions to determine whether one or more of the actions indicate an affinity for subject matter, content, other users, and so forth. As an example and not by way of limitation, if a user frequently posts content related to “coffee” or variants thereof, social-networking system 660 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular examples, social-networking system 660 may calculate a coefficient based on the type of relationship between particular objects. Referencing the social graph 700, social-networking system 660 may analyze the number and/or type of edges 706 connecting particular user nodes 702 and concept nodes 704 when calculating a coefficient. As an example and not by way of limitation, user nodes 702 that are connected by a spouse-type edge (representing that the two users are married) may be assigned a higher coefficient than user nodes 702 that are connected by a friend-type edge. In other words, depending upon the weights assigned to the actions and relationships for the particular user, the overall affinity may be determined to be higher for content about the user's spouse than for content about the user's friend. In particular examples, the relationships a user has with another object may affect the weights and/or the ratings of the user's actions with respect to calculating the coefficient for that object. As an example and not by way of limitation, if a user is tagged in a first photo, but merely likes a second photo, social-networking system 660 may determine that the user has a higher coefficient with respect to the first photo than the second photo because having a tagged-in-type relationship with content may be assigned a higher weight and/or rating than having a like-type relationship with content. In particular examples, social-networking system 660 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 660 may determine that the first user should also have a relatively high coefficient for the particular object. In particular examples, the coefficient may be based on the degree of separation between particular objects. The lower coefficient may represent the decreasing likelihood that the first user will share an interest in content objects of the user that is indirectly connected to the first user in the social graph 700. As an example and not by way of limitation, social-graph entities that are closer in the social graph 700 (i.e., fewer degrees of separation) may have a higher coefficient than entities that are further apart in the social graph 700.

In particular examples, social-networking system 660 may calculate a coefficient based on location information. Objects that are geographically closer to each other may be considered to be more related or of more interest to each other than more distant objects. In particular examples, the coefficient of a user towards a particular object may be based on the proximity of the object's location to a current location associated with the user (or the location of a client system 630 of the user). A first user may be more interested in other users or concepts that are closer to the first user. As an example and not by way of limitation, if a user is one mile from an airport and two miles from a gas station, social-networking system 660 may determine that the user has a higher coefficient for the airport than the gas station based on the proximity of the airport to the user.

In particular examples, social-networking system 660 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 660 may provide information that is relevant to user's interests and current circumstances, increasing the likelihood that they will find such information of interest. In particular examples, social-networking system 660 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular examples, social-networking system 660 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular examples, social-networking system 660 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 670 (e.g., via an API or other communication channel), or from another suitable system. In response to the request, social-networking system 660 may calculate the coefficient (or access the coefficient information if it has previously been calculated and stored). In particular examples, social-networking system 660 may measure an affinity with respect to a particular process. Different processes (both internal and external to the online social network) may request a coefficient for a particular object or set of objects. Social-networking system 660 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular examples may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, filed 1 Oct. 2012, each of which is incorporated by reference.

### Privacy

In particular examples, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) may be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page that identify a set of users that may access the work experience information on the user-profile page, thus excluding other users from accessing the information. In particular examples, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular examples, privacy settings may be associated with particular social-graph elements. Privacy settings of a social-graph element, such as a node or an edge, may specify how the social-graph element, information associated with the social-graph element, or content objects associated with the social-graph element may be accessed using the online social network. As an example and not by way of limitation, a particular concept node 704 corresponding to a particular photo may have a privacy setting specifying that the photo may only be accessed by users tagged in the photo and their friends. In particular examples, privacy settings may allow users to opt in or opt out of having their actions logged by social-networking system 660 or shared with other systems (e.g., third-party system 670). In particular examples, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 670, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular examples, one or more servers 662 may be authorization/privacy servers for enforcing privacy settings. In response to a request from a user (or other entity) for a particular object stored in a data store 664, social-networking system 660 may send a request to the data store 664 for the object. The request may identify the user associated with the request and may only be sent to the user (or a client system 630 of the user) if the authorization server determines that the user is authorized to access the object based on the privacy settings associated with the object. If the requesting user is not authorized to access the object, the authorization server may prevent the requested object from being retrieved from the data store 664, or may prevent the requested object from being sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

### Systems and Methods

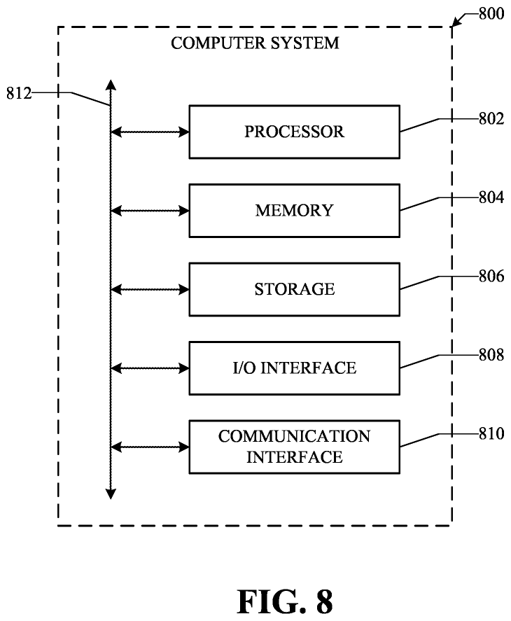

FIG. 8 illustrates an example computer system 800. The system 800 may implement one or more aspects of networked computing architecture 100 (FIGS. 1A and 1B), method 200 (FIG. 2), computing architecture 300 (FIG. 3) and/or process 400 (FIG. 4) and/or networking architecture 500 (FIG. 5) already discussed. In particular examples, one or more computer systems 800 perform one or more steps of one or more methods described or illustrated herein. In particular examples, one or more computer systems 800 provide functionality described or illustrated herein. In particular examples, software running on one or more computer systems 800 performs one or more steps of one or more methods described or illustrated herein or provides functionality described or illustrated herein. Particular examples include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular examples, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular examples, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular examples, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular examples, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular examples, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular examples, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular examples, one or more memory management units (MMUs) reside between processor 802 and memory 804 and facilitate accesses to memory 804 requested by processor 802. In particular examples, memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular examples, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular examples, storage 806 is non-volatile, solid-state memory. In particular examples, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular examples, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular examples, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular examples, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

### Examples

Example 1 includes at least one computer readable storage medium comprising a set of instructions, which when executed by a computing device, cause the computing device to identify a message that is to be transmitted across a network, divide the message into a plurality of portions that are arranged in a first order, generate a plurality of packets based on the plurality of portions, map different network paths for the plurality of packets to be transmitted to a destination, set headers of the plurality of packets to represent the first order and the different network paths, transmit the plurality of packets over the network in an out-of-order fashion to the destination based on the headers, and arrange the plurality of transmitted packets into the first order based on the headers of the plurality of packets.

Example 2 includes the at least one computer readable storage medium of Example 1, wherein the instructions, when executed, cause the computing device to maintain metrics for the different network paths.

Example 3 includes the at least one computer readable storage medium of Example 2, wherein first metrics of the metrics corresponds to a first network path of the different network paths, and the first metrics include one or more of an indication of whether the first network path is available or unavailable, a numbers of credits associated with different receivers of the destination, whether an egress port associated with the first network path is paused or an amount of data loss associated with the first network path.

Example 4 includes the at least one computer readable storage medium of Example 1, wherein the headers of the packets include first fields indicating a message number of the message, packet offset numbers indicating packet offsets within the message, and sequence numbers indicating numbers of respective paths of the different network paths assigned to the packets.

Example 5 includes the at least one computer readable storage medium of any one of Examples 1 to 4, wherein each of the packets includes a respective header of the headers, each of the headers include a network path identification that is a unique tuple representing a path of the different network paths assigned to a respective packet of the packets associated with the header, and the instructions, when executed, cause the computing device to route each of the packets according to the network path identification in the header of the packet.

Example 6 includes the at least one computer readable storage medium of any one of Examples 1 to 5, wherein the instructions, when executed, cause the computing device to transmit one or more keep alive messages over the different network paths to determine if the different network paths are responsive.

Example 7 includes the at least one computer readable storage medium of any one of Examples 1 to 6, wherein the message is associated with a remote direct memory access operation, and wherein the instructions, when executed, cause the computing device to transmit a first subset of the plurality of packets over the network in the out-of-order fashion with a first network interface card that transmits different packets over a plurality of network paths of the different network paths, wherein the first network interface card is a single network interface card, and transmit a second subset of the plurality of packets over the network in the out-of-order fashion with a second network interface card that transmits different packets over a single network path of the different network paths.

Example 8 includes a system comprising one or more processors, and a memory coupled to the one or more processors, the memory comprising instructions executable by the one or more processors, the one or more processors being operable when executing the instructions to identify a message that is to be transmitted across a network, divide the message into a plurality of portions that are arranged in a first order, generate a plurality of packets based on the plurality of portions, map different network paths for the plurality of packets to be transmitted to a destination, set headers of the plurality of packets to represent the first order and the different network paths, transmit the plurality of packets over the network in an out-of-order fashion to the destination based on the headers, and arrange the plurality of transmitted packets into the first order based on the headers of the plurality of packets.

Example 9 includes the system of Example 8, wherein the one or more processors are further operable when executing the instructions to maintain metrics for the different network paths.

Example 10 includes the system of Example 9, wherein first metrics of the metrics corresponds to a first network path of the different network paths, and the first metrics include one or more of an indication of whether the first network path is available or unavailable, a numbers of credits associated with different receivers of the destination, whether an egress port associated with the first network path is paused or an amount of data loss associated with the first network path.

Example 11 includes the system of any one of Examples 8 to 10, wherein the headers of the packets include first fields indicating a message number of the message, packet offset numbers indicating packet offset within the message, and sequence numbers indicating numbers of respective paths of the different network paths assigned to the packets.

Example 12 includes the system of any one of Examples 8 to 11, wherein each of the packets includes a respective header of the headers, each of the headers include a network path identification that is a unique tuple representing a path of the different network paths assigned to a respective packet of the packets associated with the header, and the one or more processors are further operable when executing the instructions to route each of the packets according to the network path identification in the header of the packet.

Example 13 includes the system of any one of Examples 8 to 12, wherein the one or more processors are further operable when executing the instructions to transmit one or more keep alive messages over the different network paths to determine if the different network paths are responsive.

Example 14 includes the system of any one of Examples 8 to 13, wherein the message is associated with a remote direct memory access operation, and wherein the one or more processors are further operable when executing the instructions to transmit a first subset of the plurality of packets over the network in the out-of-order fashion with a first network interface card that transmits different packets over a plurality of network paths of the different network paths, wherein the first network interface card is a single network interface card, and transmit a second subset of the plurality of packets over the network in the out-of-order fashion with a second network interface card that transmits different packets over a single network path of the different network paths.

Example 15 includes a method comprising identifying a message that is to be transmitted across a network, dividing the message into a plurality of portions that are arranged in a first order, generating a plurality of packets based on the plurality of portions, mapping different network paths for the plurality of packets to be transmitted to a destination, setting headers of the plurality of packets to represent the first order and the different network paths, transmitting the plurality of packets over the network in an out-of-order fashion to the destination based on the headers, and arranging the plurality of transmitted packets into the first order based on the headers of the plurality of packets.

Example 16 includes the method of Example 15, further comprising maintaining metrics for the different network paths.

Example 17 includes the method of Example 16, wherein first metrics of the metrics corresponds to a first network path of the different network paths, and the first metrics include one or more of an indication of whether the first network path is available or unavailable, a numbers of credits associated with different receivers of the destination, whether an egress port associated with the first network path is paused or an amount of data loss associated with the first network path.

Example 18 includes the method of any one of Examples 15 to 17, further wherein the headers of the packets include first fields indicating a message number of the message, packet offset numbers indicating packet offsets within the message, and sequence numbers indicating numbers of respective paths of the different network paths assigned to the packets.

Example 19 includes the method of any one of Examples 15 to 18, further wherein each of the packets includes a respective header of the headers, each of the headers include a network path identification that is a unique tuple representing a path of the different network paths assigned to a respective packet of the packets associated with the header, and the method further comprises routing each of the packets according to the network path identification in the header of the packet.

Example 20 includes the method of any one of Examples 15 to 19, wherein the message is associated with a remote direct memory access operation, and the method further comprises transmitting one or more keep alive messages over the different network paths to determine if the different network paths are responsive, transmitting a first subset of the plurality of packets over the network in the out-of-order fashion with a first network interface card that transmits different packets over a plurality of network paths of the different network paths, wherein the first network interface card is a single network interface card, and transmitting a second subset of the plurality of packets over the network in the out-of-order fashion with a second network interface card that transmits different packets over a single network path of the different network paths.

Example 21 includes an apparatus comprising means for identifying a message that is to be transmitted across a network, means for dividing the message into a plurality of portions that are arranged in a first order, means for generating a plurality of packets based on the plurality of portions, means for mapping different network paths for the plurality of packets to be transmitted to a destination, means for setting headers of the plurality of packets to represent the first order and the different network paths, means for transmitting the plurality of packets over the network in an out-of-order fashion to the destination based on the headers, and means for arranging the plurality of transmitted packets into the first order based on the headers of the plurality of packets.

Example 22 includes the apparatus of Example 21, wherein the apparatus includes means for maintaining metrics for the different network paths.

Example 23 includes the apparatus of Example 22, wherein first metrics of the metrics corresponds to a first network path of the different network paths, and the first metrics include one or more of an indication of whether the first network path is available or unavailable, a numbers of credits associated with different receivers of the destination, whether an egress port associated with the first network path is paused or an amount of data loss associated with the first network path.

Example 24 includes the apparatus of any one of Examples 21 to 23, wherein the headers of the packets include first fields indicating a message number of the message, packet offset numbers indicating packet offset within the message, and sequence numbers indicating numbers of respective paths of the different network paths assigned to the packets.

Example 25 includes the apparatus of any one of Examples 21 to 24, wherein each of the packets includes a respective header of the headers, each of the headers include a network path identification that is a unique tuple representing a path of the different network paths assigned to a respective packet of the packets associated with the header, and the one or more processors are further operable when executing the instructions to route each of the packets according to the network path identification in the header of the packet.

Example 26 includes the apparatus of any one of Examples 21 to 25, wherein the apparatus comprises means for transmitting one or more keep alive messages over the different network paths to determine if the different network paths are responsive.

Example 27 includes the apparatus of any one of Examples 21 to 26, wherein the message is associated with a remote direct memory access operation, and the apparatus comprises means for transmitting a first subset of the plurality of packets over the network in the out-of-order fashion with a first network interface card that transmits different packets over a plurality of network paths of the different network paths, wherein the first network interface card is a single network interface card, and means for transmitting a second subset of the plurality of packets over the network in the out-of-order fashion with a second network interface card that transmits different packets over a single network path of the different network paths.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Examples are applicable for use with all types of semiconductor integrated circuit (“IC”) chips. Examples of these IC chips include but are not limited to processors, controllers, chipset components, programmable logic arrays (PLAs), memory chips, network chips, systems on chip (SOCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary examples to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although examples are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the examples. Further, arrangements may be shown in block diagram form in order to avoid obscuring examples, and also in view of the fact that specifics with respect to implementation of such block diagram arrangements are highly dependent upon the computing system within which the example is to be implemented, i.e., such specifics should be well within purview of one skilled in the art. Where specific details (e.g., circuits) are set forth in order to describe example examples, it should be apparent to one skilled in the art that examples may be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the examples may be implemented in a variety of forms. Therefore, while the examples have been described in connection with particular examples thereof, the true scope of the examples should not be so limited since other modifications will become apparent to the skilled practitioner upon a study of the drawings, specification, and following claims.

We claim:

1. At least one computer readable storage medium comprising a set of instructions, which when executed by a computing device, cause the computing device to:
identify a message that is to be transmitted across a network;
divide the message into a plurality of portions that are arranged in a first order;
generate a plurality of packets based on the plurality of portions;
map different network paths for the plurality of packets to be transmitted to a destination;
set headers of the plurality of packets to represent the first order and the different network paths;
transmit the plurality of packets over the network in an out-of-order fashion to the destination based on the headers; and
arrange the plurality of transmitted packets into the first order based on the headers of the plurality of packets.

2. The at least one computer readable storage medium of claim 1, wherein the instructions, when executed, cause the computing device to:
maintain metrics for the different network paths.

3. The at least one computer readable storage medium of claim 2, wherein:
first metrics of the metrics corresponds to a first network path of the different network paths; and
the first metrics include one or more of an indication of whether the first network path is available or unavailable, a numbers of credits associated with different receivers of the destination, whether an egress port associated with the first network path is paused or an amount of data loss associated with the first network path.

4. The at least one computer readable storage medium of claim 1, wherein the headers of the packets include first fields indicating a message number of the message, packet offset numbers indicating packet offsets within the message, and sequence numbers indicating numbers of respective paths of the different network paths assigned to the packets.

5. The at least one computer readable storage medium of claim 1, wherein:
each of the packets includes a respective header of the headers;
each of the headers include a network path identification that is a unique tuple representing a path of the different network paths assigned to a respective packet of the packets associated with the header; and
the instructions, when executed, cause the computing device to route each of the packets according to the network path identification in the header of the packet.

6. The at least one computer readable storage medium of claim 1, wherein the instructions, when executed, cause the computing device to:
transmit one or more keep alive messages over the different network paths to determine if the different network paths are responsive.

7. The at least one computer readable storage medium of claim 1, wherein the message is associated with a remote direct memory access operation, and
wherein the instructions, when executed, cause the computing device to:
transmit a first subset of the plurality of packets over the network in the out-of-order fashion with a first network interface card that transmits different packets over a plurality of network paths of the different network paths, wherein the first network interface card is a single network interface card; and
transmit a second subset of the plurality of packets over the network in the out-of-order fashion with a second network interface card that transmits different packets over a single network path of the different network paths.

8. A system comprising:
one or more processors; and
a memory coupled to the one or more processors, the memory comprising instructions executable by the one or more processors, the one or more processors being operable when executing the instructions to:
identify a message that is to be transmitted across a network;
divide the message into a plurality of portions that are arranged in a first order;
generate a plurality of packets based on the plurality of portions;
map different network paths for the plurality of packets to be transmitted to a destination;
set headers of the plurality of packets to represent the first order and the different network paths;
transmit the plurality of packets over the network in an out-of-order fashion to the destination based on the headers; and
arrange the plurality of transmitted packets into the first order based on the headers of the plurality of packets.

9. The system of claim 8, wherein the one or more processors are further operable when executing the instructions to:
maintain metrics for the different network paths.

10. The system of claim 9, wherein:
first metrics of the metrics corresponds to a first network path of the different network paths; and
the first metrics include one or more of an indication of whether the first network path is available or unavailable, a numbers of credits associated with different receivers of the destination, whether an egress port associated with the first network path is paused or an amount of data loss associated with the first network path.

11. The system of claim 8, wherein the headers of the packets include first fields indicating a message number of the message, packet offset numbers indicating packet offset within the message, and sequence numbers indicating numbers of respective paths of the different network paths assigned to the packets.

12. The system of claim 8, wherein:
each of the packets includes a respective header of the headers;
each of the headers include a network path identification that is a unique tuple representing a path of the different network paths assigned to a respective packet of the packets associated with the header; and
the one or more processors are further operable when executing the instructions to route each of the packets according to the network path identification in the header of the packet.

13. The system of claim 8, wherein the one or more processors are further operable when executing the instructions to:
transmit one or more keep alive messages over the different network paths to determine if the different network paths are responsive.

14. The system of claim 8, wherein the message is associated with a remote direct memory access operation, and
wherein the one or more processors are further operable when executing the instructions to:
transmit a first subset of the plurality of packets over the network in the out-of-order fashion with a first network interface card that transmits different packets over a plurality of network paths of the different network paths, wherein the first network interface card is a single network interface card; and
transmit a second subset of the plurality of packets over the network in the out-of-order fashion with a second network interface card that transmits different packets over a single network path of the different network paths.

15. A method comprising:
identifying a message that is to be transmitted across a network;
dividing the message into a plurality of portions that are arranged in a first order;
generating a plurality of packets based on the plurality of portions;
mapping different network paths for the plurality of packets to be transmitted to a destination;
setting headers of the plurality of packets to represent the first order and the different network paths;
transmitting the plurality of packets over the network in an out-of-order fashion to the destination based on the headers; and
arranging the plurality of transmitted packets into the first order based on the headers of the plurality of packets.

16. The method of claim 15, further comprising:
maintaining metrics for the different network paths.

17. The method of claim 16, wherein:
first metrics of the metrics corresponds to a first network path of the different network paths; and
the first metrics include one or more of an indication of whether the first network path is available or unavailable, a numbers of credits associated with different receivers of the destination, whether an egress port associated with the first network path is paused or an amount of data loss associated with the first network path.

18. The method of claim 15, further wherein the headers of the packets include first fields indicating a message number of the message, packet offset numbers indicating packet offsets within the message, and sequence numbers indicating numbers of respective paths of the different network paths assigned to the packets.

19. The method of claim 15, further wherein:
each of the packets includes a respective header of the headers;
each of the headers include a network path identification that is a unique tuple representing a path of the different network paths assigned to a respective packet of the packets associated with the header; and
the method further comprises routing each of the packets according to the network path identification in the header of the packet.

20. The method of claim 15, wherein the message is associated with a remote direct memory access operation, and
the method further comprises:
transmitting one or more keep alive messages over the different network paths to determine if the different network paths are responsive;
transmitting a first subset of the plurality of packets over the network in the out-of-order fashion with a first network interface card that transmits different packets over a plurality of network paths of the different network paths, wherein the first network interface card is a single network interface card; and
transmitting a second subset of the plurality of packets over the network in the out-of-order fashion with a second network interface card that transmits different packets over a single network path of the different network paths.
